(19) United States
(12) Patent Application Publication
(10) Pub. No.: US 2006/0257183 A1
(43) Pub. Date: Nov. 16, 2006

(54) Image forming apparatus

(76) Inventors: Masanao Ehara, Zama-shi (JP); Shinichi Namekata, Yokohama-shi (JP); Takeshi Yamamoto, Kanagawa-ken (JP); Hiroshi Yoshinaga, Ichikawa-shi (JP); Hirofumi Ogawa, Kawasaki-shi (JP); Hiroyuki Shimada, Zama-shi (JP)

Correspondence Address: HARNESS, DICKEY & PIERCE, P.L.C., P.O. BOX 8910, RESTON, VA, 20195, US

(21) Appl. No.: 11/431,921

(22) Filed: May 11, 2006

(30) Foreign Application Priority Data
May 12, 2005 (JP) 2005-140068
Aug. 11, 2005 (JP) 2005-233797

(51) Int. Cl. G03G 15/00

(52) U.S. Cl. 399/405

(57) ABSTRACT

An image forming apparatus may include an image reading area reading an original image and preparing image information thereof, an image forming area forming an image on a sheet-shaped recording medium based on the image information, and a discharging area located therebetween, at least opening in front and including an outlet discharging the sheet-shaped recording medium with a space connected thereto, wherein at least the discharging area further includes at least an inhibitor inhibiting an object blocking discharge of the sheet-shaped recording medium from approaching the outlet through the space. Further, an image forming apparatus may include a fixer fixing an image on a sheet-shaped recording medium upon application of heat, a tray receiving the sheet-shaped recording medium, a thermodetector detecting a temperature near the tray; and an annunciator alarming that it is dangerous to take out the sheet-shaped recording medium from the tray when the temperature is not lower than a desired or predetermined temperature.

### BACKGROUND OF THE INVENTION

1. Field of the Invention

Example embodiments of the present invention relate to an image forming apparatus, for example, a copier, a printer, a facsimile, a plotter or a complex machine having plurality thereof, and more particularly to an image forming apparatus discharging papers within its chassis and having an alarm when the discharged papers are still too hot to collect.

2. Discussion of the Background

Many current image forming apparatuses discharge papers within their chassis, wherein the papers are discharged in a space between the image reading areas and image forming areas and opened at least in front, to save space.

For example, a conventional image forming apparatus, may have one of the across-the-width sides of a space into which papers are discharged and at least one of the across-the depth sides thereof are open sharing the space.

Such an image forming apparatus discharging papers within its chassis may be reduced in size, and may be easy to operate and take out the discharged papers.

The image forming apparatus discharging papers within its chassis will be explained, referring to FIG. 12.

Numeral 500 is a copier discharging papers within its chassis, 502 is an apparatus thereof, OP is an operator (hereinafter referred to as a “user”), and 545 is a discharged paper tray.

The copier 500 may include an image reading area 504 reading an image, an image forming area 505 forming the read image on a recording paper (sheet-shaped recording medium) below the image reading area 504 and a discharge area 507 therebetween including a paper outlet 540 and a space 506 connected thereto, in which papers are discharged. The discharge area 507 may open toward a front F and may be connected to the space 506. Open areas connected to the space 506 in the discharge area 507 may include the open area toward the front F and an open area at the front in FIG. 12.

As shown in FIG. 12, the user OP may stand in front of the apparatus, set an original thereon and push a start button (not shown) of an operation area 509 while pushing a pressure plate (or ADF) 503 with another hand.

After starting copy, the user OP may put his hand in the space 506 toward the paper outlet 540 through the open area toward the front F with palm side up to receive papers discharged from the paper outlet 540.

When the space 506 is seen by the user OP standing at the open front F, the view of the space 506 is interrupted by the image reading area 504 and the paper outlet 540 cannot be seen. Therefore, the user OP may carelessly place his hand near the paper outlet 540, when the papers discharged therefrom, collide against the user's OP hand and jam. Then, the user's OP hand is an obstacle preventing the recorded papers from discharging from the paper outlet 540.

Another image forming apparatus may be designed to have a short distance form its image fixer to the space to save space and achieve higher printing speed, resulting in higher temperature of the discharged papers.

When a large amount of recorded media are piled, a toner may melt to stick the recorded medium to each other, e.g., a blocking phenomenon occurs. Coolers, for example, a fan have conventionally been used to decrease the temperature of the discharged recorded media.

However, recently, it is difficult to form coolers, for example, a fan in image forming apparatuses due to space and/or energy saving considerations. Further, when the discharged recorded media is at a higher temperature, the user OP may be burned.

### SUMMARY OF THE INVENTION

Example embodiments of the present invention provide an image forming apparatus discharging recorded media within its chassis, capable of reducing or preventing the recorded media discharged from an outlet from jamming when a user's hand, placed near the outlet, collides with the recorded media.

Example embodiments of the present invention provide an image forming apparatus capable of protecting the user from being burned with the recorded media having an elevated temperature.

Example embodiments of the present invention provide an image forming apparatus including an image reading area reading an original image and prepare image information thereof, an image forming area forming an image on a sheet-shaped recording medium based on the image information, and a discharge area located therebetween, at least opening in front and including an outlet discharging the sheet-shaped recording medium with a space connected thereto, wherein at least the discharge area further comprises at least an inhibitor inhibiting an object blocking discharge of the sheet-shaped recording medium from approaching the outlet through the space.

In another example embodiment of the present invention, an image forming apparatus is provided including a fixer fixing a toner image on a recording sheet medium upon application of heat, and a tray receiving the sheet-shaped recording medium, a thermodetector detecting a temperature near the tray; and an alarm annunciating that it is dangerous to take the sheet-shaped recording medium therefrom when the temperature is not lower than predetermined.

These and other objects, features and/of advantages of the present invention will become apparent upon consideration of the following description of the example embodiments of the present invention taken in conjunction with the accompanying drawings.

### BRIEF DESCRIPTION OF THE DRAWINGS

Various other objects, features and attendant advantages of example embodiments of the present invention will be more fully appreciated as the same becomes better understood from the detailed description when considered in connection with the accompanying drawings in which like reference characters designate like corresponding parts throughout and wherein:

FIG. 1 is a perspective view illustrating an image forming apparatus to which example embodiments of the present invention may be applied;

FIG. 2 is a longitudinal sectional view illustrating the main part of the image forming apparatus in FIG. 1;

FIG. 3 is a schematic perspective view illustrating the main part of an image forming apparatus, in an example embodiment of the present invention;

FIG. 4 is an enlarged perspective view illustrating an inhibitor for use in an example embodiment of the present invention;

FIG. 5 is a schematic perspective view illustrating the main part of an image forming apparatus, in another example embodiment of the present invention;

FIG. 6 is a perspective view illustrating another image forming apparatus to which example embodiments of the present invention may be applied;

FIG. 7 is a schematic perspective view illustrating the main part of an image forming apparatus, in another example embodiment of the present invention;

FIG. 8 is an enlarged plain view illustrating a lock mechanism for use in an example embodiment of the present invention;

FIG. 9 is a schematic perspective view illustrating the main part of an image forming apparatus, in another example embodiment of the present invention;

FIG. 10 is a schematic perspective view illustrating the man part of an image forming apparatus, in another example embodiment of the present invention;

FIG. 11 is a block diagram for explaining a control formation of the main part of an image forming apparatus, in another example embodiment of the present invention;

FIG. 12 is a side view illustrating a conventional image forming apparatus discharging papers within its chassis for explaining a problem thereof;

FIG. 13 is a longitudinal sectional view illustrating another example embodiment of the image forming apparatus of the present invention;

FIG. 14 is a detail view illustrating the fixer in the image forming apparatus in FIG. 13; and

FIG. 15 is an operation flow chart of an image forming apparatus in accordance with an example embodiment of the present invention.

### DETAILED DESCRIPTION OF EXAMPLE EMBODIMENTS OF THE INVENTION

Example embodiments of the present invention provides an image forming apparatus discharging recorded media within its chassis, capable of reducing or preventing the recorded media discharged from an outlet from jamming when a user's hand placed near the outlet collides with the recorded media.

In addition, example embodiments of the present invention provide an image forming apparatus, capable of protecting the user from being burned with the recorded media having high temperature.

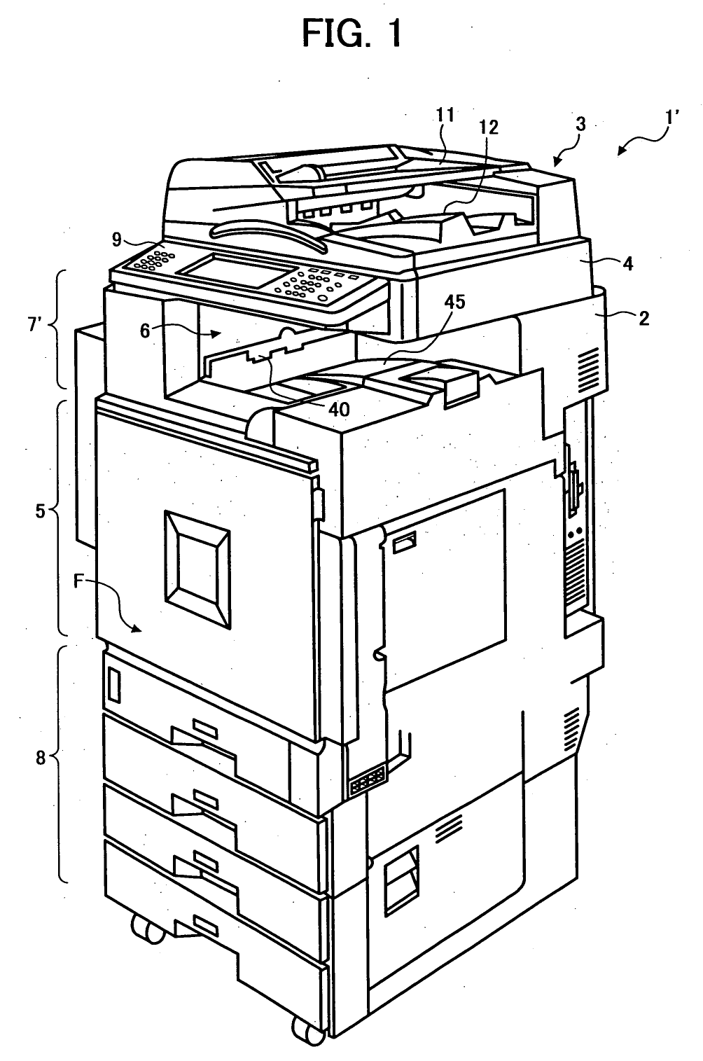

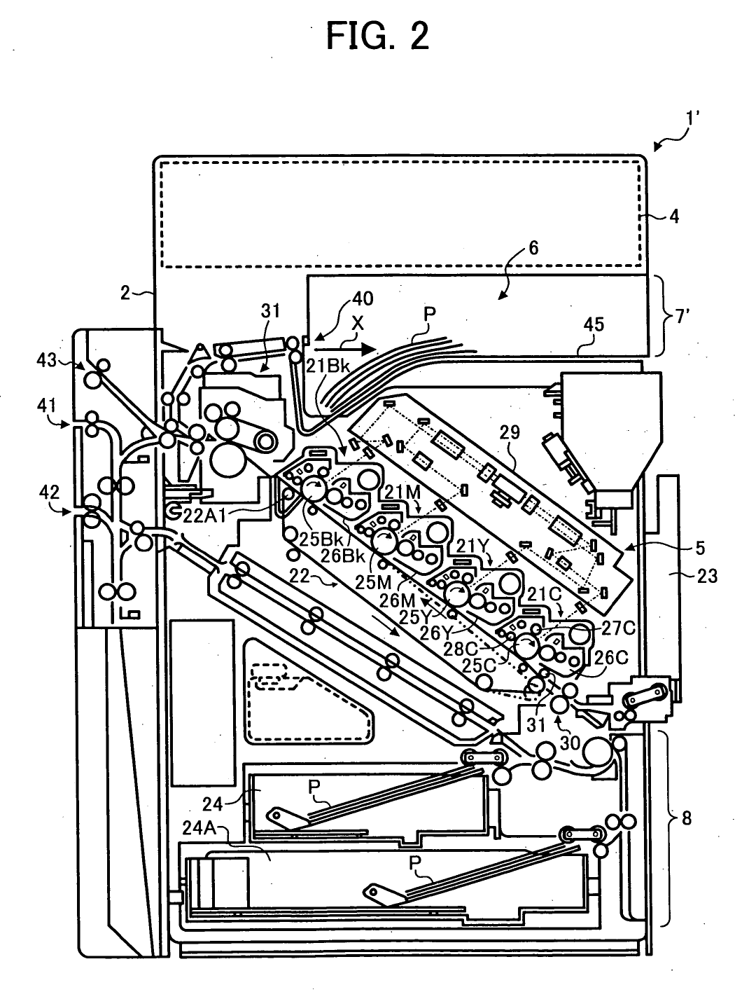

An image forming apparatus discharging papers in its chassis, to which example embodiments of the present invention may be applied, will be explained, referring to FIGS. 1 and 2.

Numeral 1′ is an image forming apparatus discharging papers in its chassis and numeral 2 is a chassis thereof. The image forming apparatus 1′ may be a full-color image forming apparatus.

The image forming apparatus 1′ may include an image reading area 4 scanning an original image set on a contact glass (not shown) to read the image information thereof; an automatic document feeder (ADF) 3 automatically feeding an original image onto the contact glass, located above the image reading area 4; an image forming area 5 forming an image on a sheet-shaped recording medium, for example, a recording paper based on the image information, located below the image reading area 4; a fixer 31 fixing the image formed by the image forming area 5; a discharge area 7′ including a space 6 a paper is discharged in and an outlet 40 an paper is discharged from; a paper feeding area 8 feeding various sheet-shaped recording media to the image forming area 5; and an operation area 9 to operate and monitoring status thereof.

The image forming area 5 may include, as shown in FIG. 2, image formers 21C, 21Y, 21M and 21Bk forming respective color images constituting an original image; a transferer 22 facing the image formers 21C, 21Y, 21M and 21Bk; and an irradiator 29 irradiating image bearers arranged therein respectively to write image information on the image bearers.

The image forming apparatus 1′ may be a tandem image forming apparatus, wherein the image formers 21C, 21Y, 21M and 21Bk are collaterally arranged at an acute angle.

The image formers 21C, 21Y, 21M and 21Bk develop colors cyan (c), yellow (Y), magenta (M) and black (Bk) respectively with developers including toners. Only the colors of toners in developers are different from each other, and the image formers 21C, 21Y, 21M and 21Bk may have the same constitution and perform the same operations. Therefore, the constitution and operation of only the image former 21C will be explained as a representative of the image formers.

The image former 21C may have a known constitution, e.g., and may include a photoreceptor drum 25C as an image bearer; and a charger 27C, an image developer 26C and a cleaner 28C sequentially located along the rotating direction of the photoreceptor drum 25C, which is irradiated by the irradiator 29 between the charger 27C and image developer 26C. The image bearer may have the shape of an endless belt instead of the shape of a drum.

The photoreceptor drum 25C may include an organic photosensitive layer on the surface thereof, and may be rotatably supported by a side board (not shown) in the clockwise direction. The irradiator 29 may be an optical system scanning a laser beam, including a laser diode (LD) irradiating a laser beam, a polygon mirror scanning the laser beam, etc.

As a transferer 22, a transferer belt may be extended between a drive roller 22A1 and a driven roller, facing photoreceptor drums 25C, 25Y, 25m and 25Bk, and may be rotated counter-clockwise to electrostatically absorb and transfer a recording paper P. The transfer belt may be located contactable to or separable from the photoreceptor drums 25C, 25Y, 25m and 25Bk.

Contact transfer rollers may be located sandwiching the transfer belt therewith.

The transfer rollers may electro-absorptively transfer toner images formed on the photoreceptor drums 25C, 25Y, 25m and 25Bk onto the recording paper P electrostatically absorbed on the transferer belt. The recording paper P may be fed from a paper feeding cassette 24, a paper feeding cassette 24A or a manual tray 23 in the paper feeding area 8 onto the transfer belt on a desired time.

The paper feeding area 8 may include the manual tray 23, and the paper feeding cassettes 24 and 24A as sheet-shaped recording media feeders feeding various sheet-shaped recording media, for example, the recording paper P; a pick up roller picking up the uppermost recording paper P from the paper feeding cassettes 24 and 24A; a paper feeder including a paper feeding roller and a separation roller; and a resist roller feeding the recording paper P in time for forming an image by the image formers 21C, 21Y, 21M and 21Bk in a transfer area wherein the image formers 21C, 21Y, 21M and 21Bk and the transferer 22 are facing each other.

The image forming apparatus 1′ is capable of forming images on any of plain paper, OHP sheets, 90K paper, for example, cards and post cards, and cardboards and envelopes having a weight not less than 100 g/m² as sheet-shaped recording media.

On the left above of the chassis 2, which is downstream of the recording paper transfer route, a separator separating the recording paper P from the transfer belt may be located facing the drive roller through the transfer belt. The fixer 31 may include a fixing roller and a pressure roller, which melts, pressurizes and fixes toner images transferred on the recording paper P, and may be located near the left side, above of the separator. Further, a pair of paper discharge rollers may be located above the fixer 31 through a paper discharge guide plate. The (paper) discharge area 7′ including a discharged paper tray 45 may be located on the right side, below of the pair of paper discharge rollers.

The discharge area 7′ may open in front F of the chassis 2 and on one side thereof each connected to the discharge space 6.

In the image forming apparatus 1′, the recording paper may be discharged from the outlet 40 toward the open side (not in front F) and may be placed on the discharged paper tray 45.

A user OP may take out a recording paper a toner image is formed on placing a hand through the open front F of the chassis 2 or one the side thereof. In an example embodiment, the user's hand may be considered an obstacle preventing the recorded paper from discharging from the paper outlet 40.

In FIGS. 1 and 2, the discharge direction of the recording paper is from left to right, but may be from right to left.

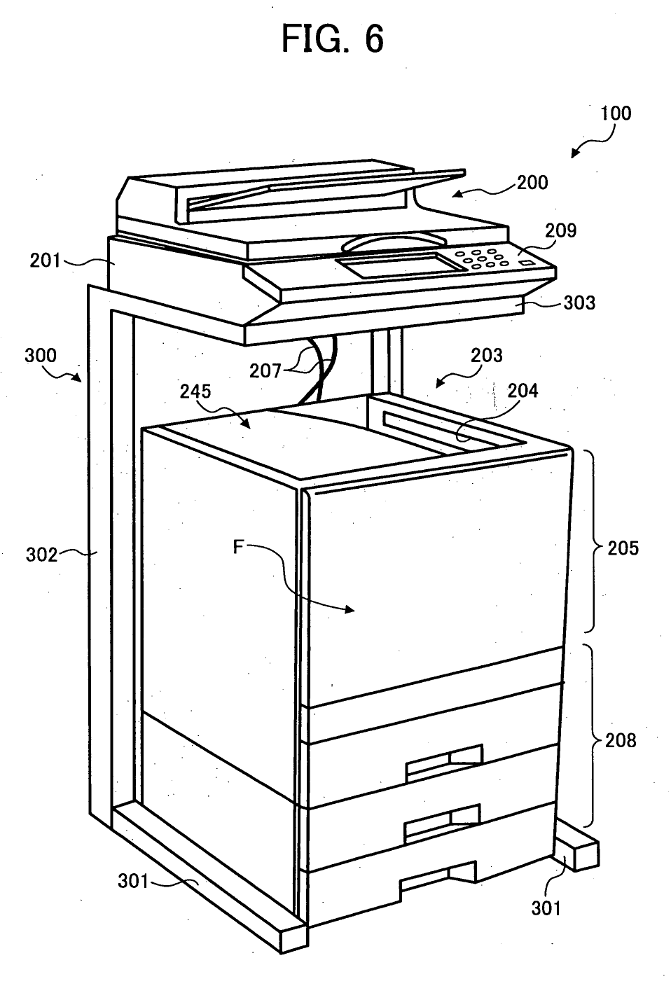

In example embodiments of the present invention, an image reading area and an image forming area may be separate from each other as shown in FIG. 6.

Explanations of known constitutions and operations of the ADF 3 and the image reading area 4 are omitted.

A full-color image forming operation will be explained, referring to FIGS. 1 and 2.

When a start button on the operating area 9 is pushed to transmit a signal of forming a full-color image to a controller (not shown), the image formers 21C, 21Y, 21M and 21Bk operates to form cyan (c), yellow (Y), magenta (M) and black (Bk) toner images on the photoreceptor drums 25C, 25Y, 25m and 25Bk, respectively. When the image former 21C is exemplified, while the photoreceptor drum 25C rotates clockwise, the surface thereof is uniformly charged by the charger 27C. The LD of the irradiator 29 may irradiate a laser beam thereto based on an image signal, and an electrostatic latent image may be formed thereon while scanned by a polygon mirror. When the photoreceptor drum 25C the electrostatic latent image is formed on faces the image developer 26C, a developing roller as a developer bearer may transfer a developer to a nip facing the photoreceptor drum 25C, wherein a toner in the developer is fed and absorbed to the electrostatic latent image formed on the photoreceptor drum 25C to be developed and form a cyan (C) toner image thereon.

The other image formers 21Y, 21M and 21Bk similarly form respective toner images.

The recording paper P set in the paper feeding cassette 24 may be taken out by the paper feeder, and transferred to a pair of resist rollers 30. The pair of resist rollers 30 may transfer an end of the recording paper P to a transfer area of the photoreceptor drum 25C such that the cyan (C) toner image formed thereon fits on the recording paper P.

When the cyan (C) toner image is electro-absorptively transferred onto the recording paper P by the transfer roller of the transferer 22, the recording paper P may be electrostatically absorbed to the transfer belt. The transfer belt may sequentially transfer the recording paper P between the photoreceptor drums 25Y, 25m and 25Bk and the respective transfer rollers, and the yellow (Y), magenta (M) and black (Bk) toner images formed thereon respectively may be sequentially transferred onto the recording paper P. Thus, all the color toner images may be transferred thereon to form an integrated full-color toner image thereon.

After the recording paper P a full-color toner image is formed on is separated from the separator, the recording paper P may be transferred to the fixer 31, wherein the full-color toner image may be melted, pressurized and fixed thereon. The recording paper P a full-color image is formed on may be transferred to one of outlets 40 to 43 by known techniques, for example, a transfer roller and a changeover pick. When discharged from the outlet 40, the recording paper P may be discharged by the pair of paper discharge rollers and piled on the discharged paper tray 45. When discharged from the outlet 43, the recording paper P may be transferred to a following process (no shown) by a transfer roller, etc. When discharged from the outlet 41 or 42, the recording paper P may be turned upside down such that an image is formed on the other side thereof e.g., subject to double-sided printing.

The cleaner 28C may remove residual toner remaining on the surface of the photoreceptor drum 25C with a cleaning blade, which is untransferred onto the recording paper P, and may collect and store the toner in a waste toner bottle. The surface of the photoreceptor drum 25C may be charged by the charger 37C after passing the cleaner 28C to repeat another image forming process. The other image formers 21Y, 21M and 21Bk may perform the same operations.

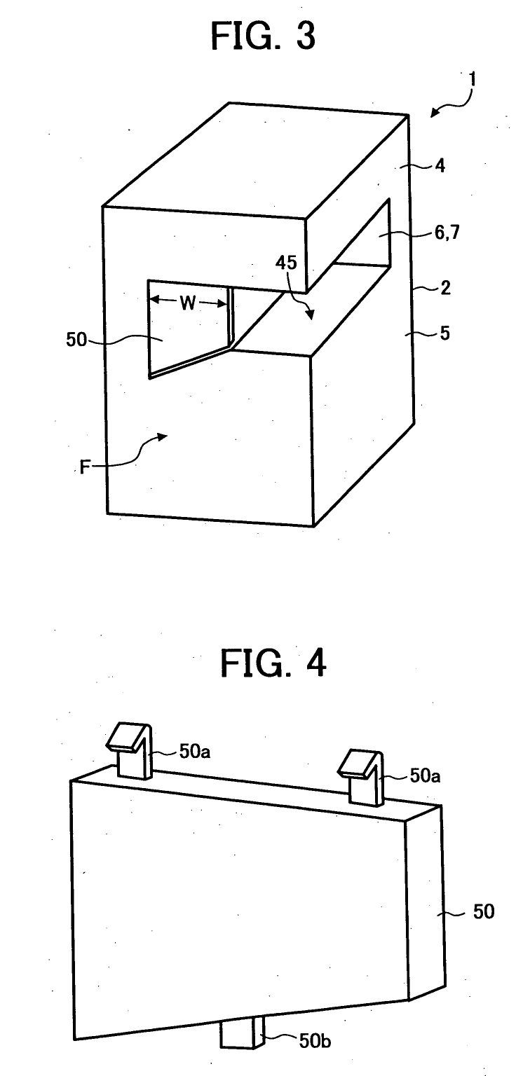

An example embodiment of the image forming apparatus 1 of the present invention is shown in FIGS. 3 and 4.

In comparison with the image forming apparatus 1′ in FIGS. 1 and 2, the image forming apparatus 1 differs in having a discharge area 7 including an inhibitor 50 preventing an obstacle, which blocks the discharge of the recording paper P, from coming therein instead of the discharge area 7′.

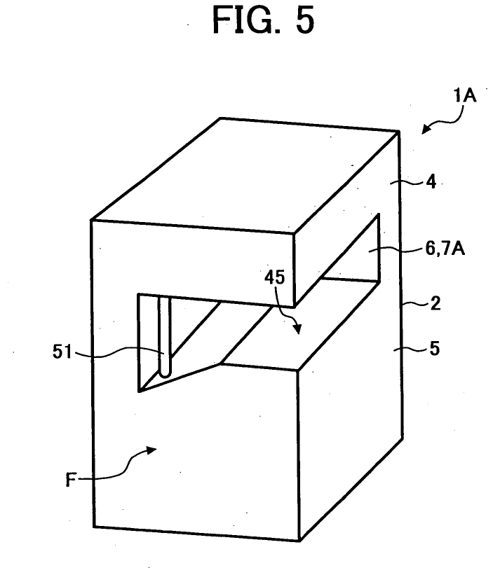

In an example embodiment, the inhibitor 50 may be the shape of a wall or a wall plate to prevent a hand of a user from carelessly coming near an outlet 40 (not shown in FIG. 3 to be simplified, this is same in FIGS. 5, 7, 9 and 10) through the open front F of a chassis 2.

The inhibitor 50 may be a plate formed of the same resin as that of the exterior cover of the apparatus, and may have the shape of a portion of the open front F by the outlet 40 as shown in FIGS. 3 and 4.

The inhibitor 50 may include an upper salient 50a and a lower salient 50b in a body. In FIG. 3, the lower surface of the chassis of an image reader 4 and the frontal chassis of the discharge area 7 may have engage holes (not shown) to be engaged with the salient 50a and the lower salient 50b, respectively. Fixed by being engaged with the engage holes, the inhibitor 50 may be more easily detachable, maintained and exchanged than fixed by being screwed.

For example, the horizontal width of the inhibitor 50 may be about 200 mm at shortest in consideration of the shorter length of A4 size recording paper. Even when the size of the recording paper is larger than A4, the recording paper may reach the bottom of the discharged paper tray 45 when transferred over the width by its firmness, and there is less possibility of jamming recording papers even when a hand enters a paper discharge space 6.

Therefore, a user may not carelessly or unconsciously place his hand near the outlet 40.

The inhibitor 50 may have the shape of a wall, which is completely fixed in FIGS. 3 and 4, and may be formed of a transformable material such as a rubber and a film, and may further have the shape of a curtain, for example, a blind. For example, any inhibitors calling a user's attention when he places his hand near the outlet 40 may be used. The inhibitor 50 may also include a peripheral part having a warning label.

In example embodiments of the present invention, the same inhibitor may be formed on the right (other) open side as well in case a hand is placed in therethrough. This is also true for other example embodiments and modified example embodiments mentioned later.

In addition, because the recoding paper P being discharged near the outlet 40 may have an elevated temperature, the inhibitor may prevent the hand from contacting thereto.

FIG. 5 is a schematic perspective view illustrating the main part of an image forming apparatus 1A, in another example embodiment. The image forming apparatus 1A may differ in having a discharge area 7A including an inhibitor 51 instead of the discharge area 7 including the inhibitor 50.

The inhibitor 51 may have the shape of a bar having the same purpose and capability as that of the inhibitor 50. For example, the inhibitor 51 may be located closer to an outlet 40 (not shown). The inhibitor 51 may be formed of a tough and hard material or a soft material such as a rubber. Further, the inhibitor 51 may have a linear shape. The inhibitor 51 may be connected to a chassis 2, the same as the inhibitor 50.

The inhibitor 50 or 51 may be applied to an image forming apparatus 100 in FIG. 6, wherein an image reading area 201 and an image forming area 205 are separate from each other.

In the image forming apparatus 100, the image reading area 201 and an ADF 200 may be loaded on a rack 300 including legs 301, supports 302 and an image reading area table 303. The image reading area 201 and an operation area 209 may be communicably connected to the image forming area 205 through a cable 207. Various signals from the image reading area 201 and the operation area 209 may be transmitted through the cable 207 to the image forming area 205 as image data signals, etc., and they are capable of transmitting and receiving various signals to and from each other.

In FIG. 6, numeral 208 is a paper feeding area, 203 is a discharge area and 204 is a paper outlet therein.

The lower salient 50b of the inhibitor 50 may be engaged with an engage hole (not shown) on a discharged paper tray 245 to be fixed thereon toward a front F, and the upper salient 50a may be engaged with an engage hole (not shown) on an under surface cover of the image reading area 201 or of the image reading area table 303 to be fixed thereon.

In addition, a cover covering the discharged paper tray 245 may be located above the discharged paper tray 245 besides the inhibitor 50.

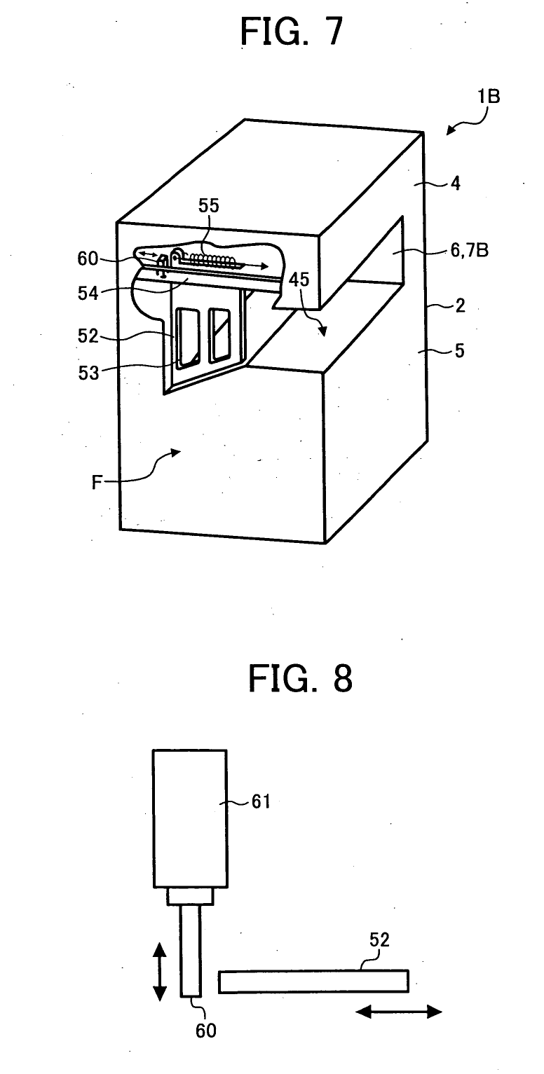

FIG. 7 is a schematic perspective view illustrating the main part of an image forming apparatus 1B, in another example embodiment of the present invention; and FIG. 8 is an enlarged plain view illustrating a lock mechanism for use therein.

The image forming apparatus 1B may differ in having a discharge area 7B including a displaceable (movable) inhibitor 52 instead of the discharge area 7 including the fixed inhibitor 50.

A recording paper may be more difficult to take out from the discharged paper tray 45 when the inhibitor 50 or 51 is fixed on the chassis 2. In an example embodiment, the inhibitor 52 may be displaceable (movable) between an inhibiting position and a disinhibiting position, and a lock system preventing the inhibitor 52 from moving to the disinhibiting position while the recorded paper is discharged onto the discharged paper tray 45.

In an example embodiment of the present invention, being displaceable includes being oscillatable, e.g., being turnable at a desired angle besides being movable.

In FIG. 7, a displacer or a transferer making the inhibitor 52 displaceable (movable) between the inhibiting position and the disinhibiting position may be located suspending at the bottom of an image reader 4 in front, and mainly includes a rail 54 movably guiding and supporting the inhibitor 52 and a spring 55 biasing the inhibitor 52 in the direction of the inhibiting position.

The inhibitor 52 may be formed of a member having the shape of a plate and may have an opening 53 having such a size as a hand is inplaceable therethrough while ensuring the visibility of the discharge area 7B.

The rail 54 may have a guide regle having the shape of □, loosely fitting the inhibitor 52 therein. An end of the spring 55 may be locked to the inhibitor 52, and the other end thereof may be locked to a chassis 2 of the image reader 4. The spring 55 may pull the inhibitor 52 to the right in FIG. 7 while keeping a gap between the left side thereof and the chassis so as not to allow a hand to enter therein.

In the discharge area 7B, the left of an outlet 40 in the chassis may have an escape opening (not shown) accepting the inhibitor 52 in a disinhibiting position.

Therefore, when a user takes out the recording paper from the discharged paper tray 45, the inhibitor 52 is slid to the left in the disinhibiting position against the bias of the spring 55. The inhibitor 52 is slid from side to side in an example embodiment, but may also be slid up and down, or aslant.

The lock system, preventing the inhibitor 52 from moving to the disinhibiting position while the recorded paper is discharged onto the discharged paper tray 45, may include a solenoid 61 and a block 60 which is a plunger connected thereto. The solenoid 61 may include a spring pulling the block 61 back therein, and may be fixed on the chassis 2 of the image reader 4. While the recorded paper is discharged onto the discharged paper tray 45, the solenoid 61 may project the block 60 to block the inhibitor 52 from moving to the disinhibiting position so as not to allow a hand to enter therein.

Therefore, an example embodiment may also improve workability of a user taking out a recording paper from the discharged paper tray 45.

In addition, the lock system regulating and prohibiting a movement of the inhibitor 52 to the disinhibiting position may prevent a hand from being burned near the outlet 40 and possibility thereof.

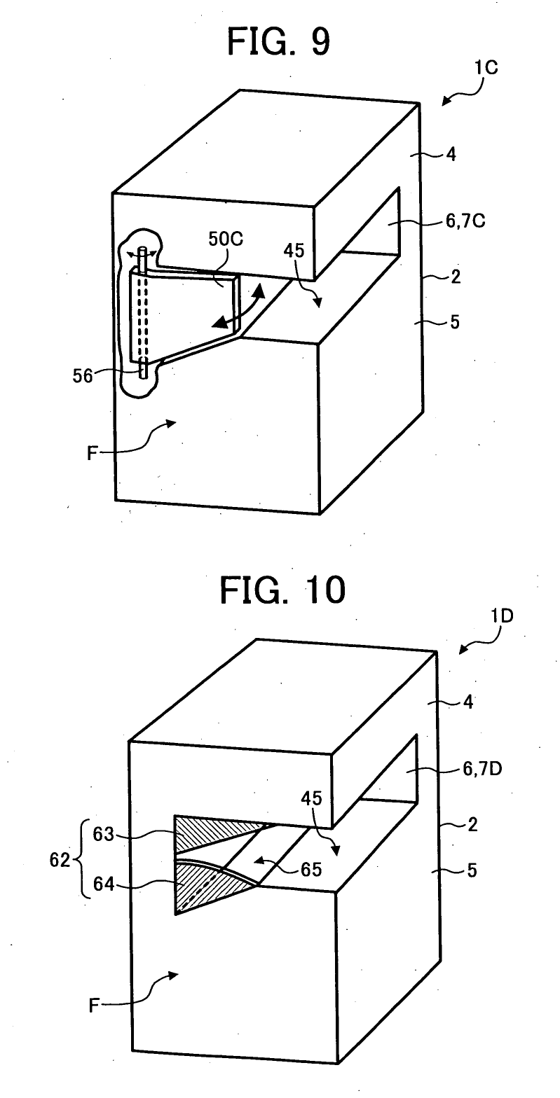

FIG. 9 is a schematic perspective view illustrating the main part of an image forming apparatus 1C, in an example embodiment. The image forming apparatus 1C may differ in having a discharge area 7C including an inhibitor 50C instead of the discharge area 7 including the inhibitor 50.

The inhibitor 50C may be the same as the inhibitor 50 except for being fixed at the left on a shaft 56 rotatably supported through bearings on the under surface of an image reader 4 and the bottom of an discharge area 7C.

The inhibitor 50C may have the shape of a pivoted door having a regulated pivot angle. Namely, the inhibitor 50C may prevent an obstacle from entering the discharge area 7C when staying at a (an inhibiting) position as FIG. 9 shows, and allows an obstacle to come therein while pivoting in front.

From the under surface of the image reader 4, a stopper (not shown) may be contactably projected to the inhibitor 50C for positioning the inhibitor 50C at the inhibiting position so as not to pivot back. A bias, for example, a coil spring may be formed around the shaft 56, and on the under surface of the image reader 4 and the backbone of the inhibitor 50C to constantly bias the inhibitor 50C to the inhibiting position.

Therefore, the inhibitor 50C may be pivoted in front at a desired angle for a user to take out the recording paper from the discharged paper tray 45.

The lock system in FIG. 8 may be used as the stopper, when a block hole engaged with the block 60 of the solenoid 61 may be formed on the top of the inhibitor 50C.

FIG. 10 is a schematic perspective view illustrating the main part of an image forming apparatus 1D, in an example embodiment of the present invention. The image forming apparatus 1D may differ in having a discharge area 7D including an inhibitor 62 instead of the discharge area 7 including the inhibitor 50.

The inhibitor 50 or 51 in FIG. 3 or 5 may be simply fixed on the chassis 2, and may be difficult for a user to take out take out the recording paper from the discharged paper tray 45.

The inhibitor 62 may have an opening 65 narrow near the outlet 40 and gradually becoming wider with a distance therefrom.

The inhibitor 62 may include an upper part 63 of the inhibitor and a lower part 64 thereof having specific outlines respectively so as to form the opening 65. The upper part 63 and lower part 64 of the inhibitor may be formed of a member having the shape of a plate wall, and fixed as shown in FIG. 10.

The opening 65 of the inhibitor 62 may be narrow near the outlet 40 so as not to allow a hand of a user to come in and gradually becoming wider rightward so as to ensure a user taking out the recording paper from the discharged paper tray 45. The opening may have a shape that gradually widens with distance up to 200 mm from the outlet 40. The lower part 64 may have almost the same shape as a transfer track of the recording paper discharged, such that a user does not place his hand thereunder.

The inhibitor 62 may have an opening 53 having such a size as a hand is inplaceable therethrough while ensuring the visibility of the discharge area 7D.

Therefore, the image forming apparatus 1D which has the inhibitor 62 in front F, having the opening 65 being narrow near the outlet 40 and gradually becoming wider with distance therefrom, may have the same advantage and effect as discussed above.

The inhibitors 50, 51, 52, 50C, 62 and similar inhibitors may be formed of transparent materials. For example, the inhibitors 50, 51, 52, 50C, 62 may be formed of materials, for example, an acrylic resin and a polycarbonate resin, which may improve the visibility of the discharged paper tray 45 to prevent the discharged recording paper from being left thereon.

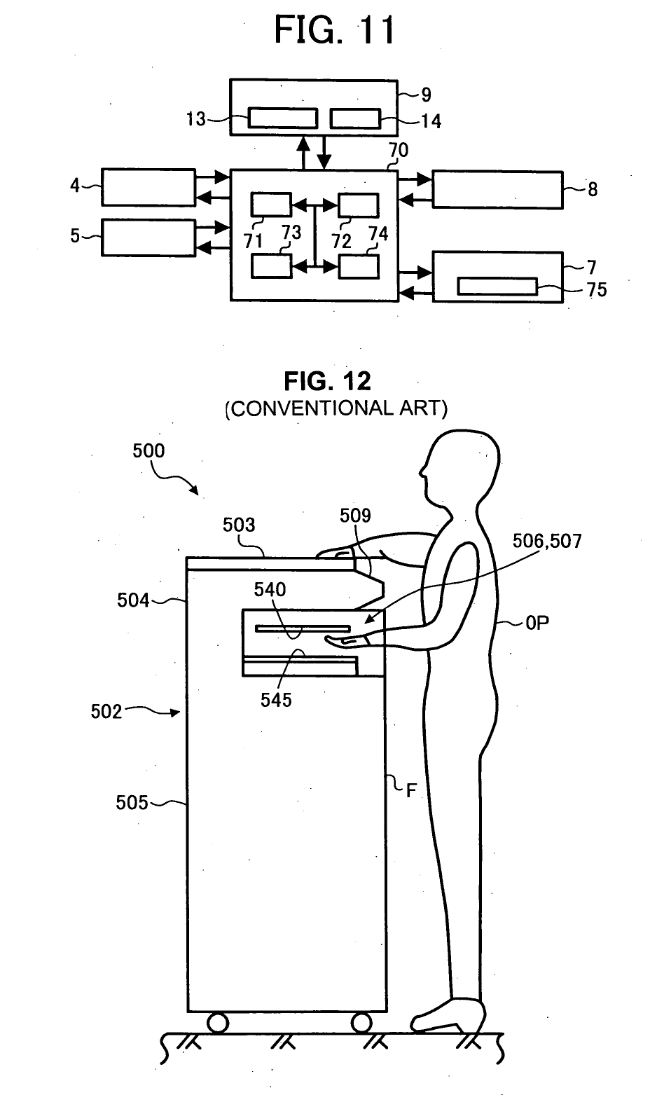

Another example embodiment will be explained, referring to FIG. 11. A control system thereof will briefly be explained, using the image forming apparatus 1 of FIG. 3.

Another example embodiment may include a light reflex photosensor 75 located at the right end of the inhibitor 50, detecting a contact of a user's hand thereto, a LCD 13 and a buzzer 14 as an alarm, and a controller 70 controlling the LCD 13 and buzzer 14 based on an output signal from the photosensor 75.

The controller 70 may have a microcomputer including a CPU 71, a ROM 72, a RAM 73, a timer (not shown), an I/O (input and output report) 74, etc.

The CPU 71 may control total operations of the image forming apparatus 1 such as operations of respective drive means, e.g., actuators such as motors and solenoids for the ADF 3, image reading area 4, image forming area 5, discharge area 7, paper feeding area, and those of the LCD 13 and buzzer 14 in the operating area 9, based on various signals from various buttons and keys such as a start button and a numerical keypad, an output signal from the photosensor 75 on the inhibitor 50 in the discharge area 7, various output signals from various sensors on the chassis 2 and an operation program called up from the ROM 72.

All operation programs of the image forming apparatus 1 and data concerned may be stored in the ROM 72, and the operation programs may be called up by the CPU 71 when necessary. The RAM 73 may temporarily store a computed result of the CPU 71, and store when necessary an on or off signal from the photosensor 75, and data signals and on or off signals set and input by the various buttons and keys on the operating area 9. The CPU 71, ROM 72 and RAM 73 may only perform operations specified in example embodiments of the present invention.

The CPU 71 may make the LCD 13 display caution and alarm and the buzzer 14 buzz therefor, based on an on a signal from the photosensor 75, when a user's hand contacts the inhibitor 50.

In example embodiments of the preset invention, of the LCD 13 or the buzzer 14 may be used. In addition, most suitable lighting and blinking means such as means using a LED or the like means may be used in consideration of reliability, cost, etc.

Any known sensors or switches instead of the photosensor 75 may be used to detect contacts to the inhibitors in consideration of detection preciseness, cost, etc. For example, a sensor or a touch sensor which is on even with a light touch may be used. Alternatively, an approach sensor may optionally be used, which is on when a user's hand comes within a given distance of the inhibitor.

Therefore, example embodiments having the controller 70 making the LCD 13 display caution and alarm and the buzzer 14 buzz therefor more definitely prevents a user from carelessly and unconsciously placing his hand near the outlet 40, more definitely prevents the user's hand from contacting the recording paper being discharged, and more definitely prevents the recording paper from being jammed.

The image forming apparatus 1B or 1C having a displaceable inhibitor 52 or 50C may have a sensor detecting slide or movement of the inhibitor 52, or oscillation or opening and closing of the inhibitor 50C. Specific examples of the sensor include a light reflex photosensor, a light transmittance photosensor and switches, for example, a limit switch.

Since details of the sensors such as locations thereof at the inhibitors, controllers thereof and applications thereof are easily embodied by those skilled in the art, additional explanation is omitted.

The image forming apparatus of example embodiments of the present invention is not limited to the above, and may be any space-saving image forming apparatuses discharging paper within their chasses, for example, an image forming apparatus disclosed in FIG. 1 or 7 in Japanese Laid-Open Patent Publication No. 2002-354173; an image forming apparatus disclosed in FIG. 1 in Japanese Laid-Open Patent Publication No. 2000-72310, having plural discharged paper trays up and down; and an image forming apparatus disclosed in FIG. 1 in Japanese Laid-Open Patent Publication No. 2002-62711, wherein an additional image reader is loaded thereon.

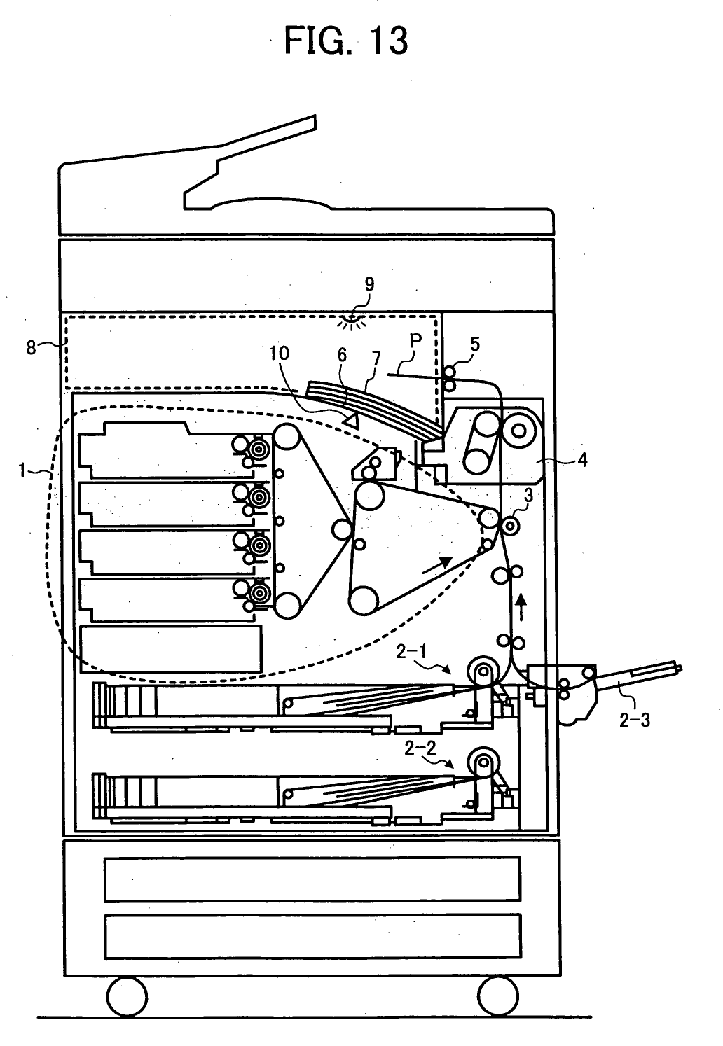

FIG. 13 is a longitudinal sectional view illustrating another example embodiment of the image forming apparatus of the present invention, which includes a toner image forming system 1 having charging, irradiating, developing and intermediate-transferring units.

Paper feeders 2-1 and 2-2 may be located below the toner image forming system 1, and a manual paper feeder 2-3 is located laterally thereto. Four color toner images developed by the toner image forming system 1 may be transferred onto a recording medium vertically transferred by a transferer 3.

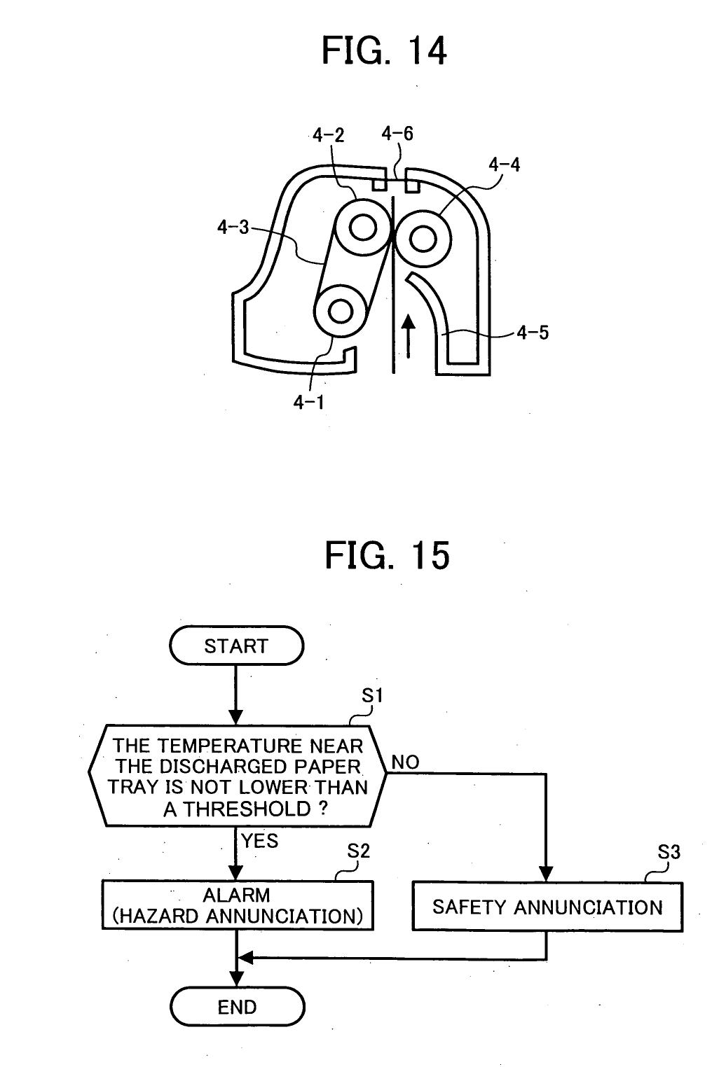

The recording medium may enter a heating fixer 4 after passing through the transferer 3. FIG. 14 is a detail view of the fixer. The fixer 4 may include a heat roller 4-1 including a heat source; a fixing roller 4-2 formed of a metal shaft coated with a silicone sponge or a silicone rubber; a seamless belt 4-3 extended rotating among the heat roller 4-1, fixing roller 4-2 and a tension roller (not shown); a pressure roller 4-4 pressurizing the fixing roller 4-2 through the seamless belt 4-3 to form a fixing nip; a guide 4-5 introducing the recording medium into the fixing nip; and a guide 4-6 sending the recording medium out thereof.

The recoding medium on which a toner image is heated, melted and fixed may be transferred to a discharge roller 5, and discharged on a discharged paper tray 6. A bulk 7 of the recording medium gradually reduces its temperature, emitting heat. Above the discharged paper tray 6 may be a large space 8. The space 8 may have an upper surface having a light source 9 on. This will be explained later.

A temperature sensor 10 may be located near the discharged paper tray 6. A user might be burned when taking out a recording medium P being discharged from the discharge roller 5 or the bulk 7 of the recording medium having an elevated temperature. The temperature sensor 10 detects the surface temperature thereof.

The above-mentioned components may be controlled by a CPU (not shown).

FIG. 15 is an operation flow chart of the image forming apparatus of example embodiments of the present invention. Based on an output of the temperature sensor 10, whether the temperature near the discharged paper tray 6 (caused by the temperature of the recording medium P or the bulk 7 of the recording medium) is higher than a threshold is determined (S1). When higher than the threshold, a user is alarmed not to take out the recording medium soon (S2) [a danger annunciation]. When lower than the threshold, a user is allowed to take out the recording medium soon [a safety annunciation]. In addition, a discharged paper sensor (not shown) may detect the recording medium P being discharged from the discharge roller 5 and alarm.

The annunciation may be performed by lighting and blinking the light source 9. Besides, the annunciation may be displayed on an operation panel (not shown) of the image forming apparatus, or be performed by lighting and blinking a coloring LED lamp located at a well-visible site from outside. For example, a red LED lamp is lighted as a danger annunciation, and a green LED lamp is lighted as a safety annunciation. The annunciation may be performed by a voice output.

The safety and danger may be annunciated by predicting the surface temperature of the recording medium without actually measuring the temperature. Preliminarily determining a relationship between the surface temperature of the recording medium and a fixing temperature, the safety annunciation may be controlled to be late when the fixing temperature is high so as to increase the safety. The safety annunciation may be made early when the fixing temperature is lower such that a user can quickly take out the printed recording medium.

The surface temperature of the recording medium may differ according to the thickness, material and/or size. The relationships between the fixing temperature and the medium type may also be considered to make the safety annunciation time shortest. The information of the recording medium may be based on an automatic preset value or a manual preset value of the paper feeding tray or when starting printing.

This application claims priority and contains subject matter related to Japanese Patent Applications Nos. 2005-140068 and 2005-233797, filed on May 12, 2005, and Aug. 11, 2005, respectively, the entire contents of each of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An image forming apparatus, comprising:
an image reading area configured to read an original image and prepare image information thereof;
an image forming area configured to form an image on a sheet-shaped recording medium based on the image information; and
a discharging area located therebetween, at least opening in front, including:
an outlet configured to discharge the sheet-shaped recording medium with a space connected thereto,
wherein at least the discharging area further includes at least an inhibitor configured to inhibit an object blocking discharge of the sheet-shaped recording medium from approaching the outlet through the space.

2. The image forming apparatus of claim 1, wherein the inhibitor acts as a door to the space.

3. The image forming apparatus of claim 1, wherein a shape of the inhibitor is a quadrilateral.

4. The image forming apparatus of claim 1, wherein a shape of the inhibitor is cylindrical.

5. The image forming apparatus of claim 1, wherein the inhibitor has an opening narrower near the outlet and gradually becoming wider with a distance therefrom.

6. The image forming apparatus of claim 1, wherein a shape of the inhibitor inhibits the object from coming in the space.

7. The image forming apparatus of claim 1, wherein the inhibitor is formed of a transparent material.

8. The image forming apparatus of claim 1, wherein the inhibitor is displaceable between an inhibiting position inhibiting the object from coming in the space and an allowing position allowing the object to come therein.

9. The image forming apparatus of claim 8, further comprising a lock system configured to prevent the inhibitor from transferring to the inhibiting position while discharging the sheet-shaped recording medium on which an image is formed.

10. The image forming apparatus of claim 1, wherein the inhibitor is moveable along a rail via a spring.

11. The image forming apparatus of claim 1, wherein the inhibitor is rotatable on a shaft.

12. The image forming apparatus of claim 1, wherein the inhibitor is detachable from the image forming apparatus.

13. The image forming apparatus of claim 1, wherein the image reading area and the image forming area are adjacent to each other.

14. The image forming apparatus of claim 1, wherein the image reading area and the image forming area are separate from each other.

15. The image forming apparatus of claim 1, further comprising an alarm configured to alarm when the object contacts the inhibitor.

16. An image forming apparatus, comprising:
a fixer configured to fix an image on a sheet-shaped recording medium upon application of heat; and
a tray configured to receive the sheet-shaped recording medium, a thermodetector configured to detect a temperature near the tray; and
an annunciator configured to alarm that it is dangerous to take out the sheet-shaped recording medium from the tray when the temperature is not lower than a desired temperature.

17. The image forming apparatus of claim 16, wherein the annunciator annunciates that it is possible to take out the sheet-shaped recording medium from the tray when the temperature is lower than the desired temperature.
